(19) United States
(12) Patent Application Publication
(10) Pub. No.: US 2026/0292195 A1
(43) Pub. Date: Sep. 24, 2026

(54) COMPRESSING APPARATUS, COMPRESSION METHOD, MEDIUM, AND SYSTEM

(71) Applicant: Mitsubishi Electric Corporation, Tokyo (JP)

(72) Inventor: Teng-Yok LEE, Tokyo (JP)

(73) Assignee: Mitsubishi Electric Corporation, Tokyo (JP)

(21) Appl. No.: 19/694,166

(22) Filed: Jun. 1, 2026

Related U.S. Application Data
(63) Continuation of application No. PCT/JP2024/002718, filed on Jan. 30, 2024.

(51) Int. Cl. H04N 19/136; H04N 19/119

(52) U.S. Cl. CPC H04N 19/136; H04N 19/119

(57) ABSTRACT

A compressing apparatus includes: a matrix acquiring unit to sequentially acquire a partial feature matrix for each of a plurality of partial images that are obtained by splitting an image; and a first global matrix calculating unit to calculate a first global singular value matrix which is a first global singular value matrix and includes a singular value of a first partial feature matrix, and a first global right singular matrix which is a first global right singular matrix and includes a right singular vector corresponding to the singular value of the first partial feature matrix, by singular-value-decomposing the first partial feature matrix which is a partial feature matrix acquired first by the matrix acquiring unit.

### CROSS REFERENCE TO RELATED APPLICATIONS

This application is a Continuation of PCT International Application No. PCT/JP2024/002718 filed on Jan. 30, 2024, which is hereby expressly incorporated by reference into the present application.

### TECHNICAL FIELD

The present disclosure relates to a compressing apparatus, a compression method, a medium, and a system.

### BACKGROUND ART

There are compressing apparatuses to compress feature matrices representing features of an image.

As such a compressing apparatus, for example, Patent Literature 1 discloses a method in which a processing apparatus compresses feature matrices by singular-value-decomposing (Singular Value Decomposition: SVD) the feature matrices.

### CITATION LIST

### Patent Literatures

Patent Literature 1: JP 2014-10495 A

### SUMMARY OF INVENTION

### Technical Problem

The method disclosed in Patent Literature 1 requires storage of all of the feature matrices on a memory of the processing apparatus in order for the processing apparatus to SVD the feature matrices. The memory of the processing apparatus is a memory for work such as a Random Access Memory (RAM) for temporarily saving data, and is different from a storage apparatus such as a hard disk for saving data for a long period. Since the data size of feature matrices is typically large, the method disclosed in Patent Literature 1 has a problem that the processing apparatus needs to have a high-capacity memory mounted thereon.

The present disclosure has been made to solve the problem described above, and an object thereof is to obtain a compressing apparatus that can enable compression of feature matrices simply by storing parts of the feature matrices on a memory.

### Solution to Problem

A compressing apparatus according to the present disclosure includes: matrix acquiring circuitry to sequentially acquire a partial feature matrix for each of a plurality of partial images that are obtained by splitting an image; and first global matrix calculating circuitry to calculate: a first global singular value matrix which is a first global singular value matrix and includes a singular value of a first partial feature matrix, and a first global right singular matrix which is a first global right singular matrix and includes a right singular vector corresponding to the singular value of the first partial feature matrix, by singular-value-decomposing the first partial feature matrix which is a partial feature matrix acquired first by the matrix acquiring circuitry. In addition, the compressing apparatus includes: target matrix calculating circuitry to calculate a b-th target matrix which is a matrix of a b-th singular value decomposition target and includes: a b-th partial feature matrix which is a partial feature matrix acquired b-th (b is an integer which is equal to or greater than two) by the matrix acquiring circuitry, a (b-1)-th global singular value matrix, and a (b-1)-th global right singular matrix; and second global matrix calculating circuitry to singular-value-decompose the b-th target matrix calculated by the target matrix calculating circuitry, calculate, as a b-th global singular value matrix, a singular value matrix of the b-th target matrix including a singular value of the b-th target matrix, and calculate, as a b-th global right singular matrix, a right singular matrix of the b-th target matrix including a right singular vector corresponding to the singular value of the b-th target matrix.

### Advantageous Effects of Invention

The present disclosure enables compression of feature matrices simply by storing parts of the feature matrices on a memory.

### BRIEF DESCRIPTION OF DRAWINGS

FIG. 1 is a configuration diagram depicting a system including a compressing apparatus 101 according to a first embodiment.

FIG. 2 is a hardware configuration diagram depicting hardware of the compressing apparatus 101 according to the first embodiment.

FIG. 3 is a hardware configuration diagram of a computer in a case where the compressing apparatus 101 is implemented by software, firmware, or the like.

FIG. 4 is an explanatory diagram depicting a feature matrix after compression by a compression method disclosed in Patent Literature 1.

FIG. 5 is a flowchart depicting a compression method which is a processing procedure performed by the compressing apparatus 101.

FIG. 6 is an explanatory diagram depicting a plurality of partial images included in an image.

FIG. 7 is an explanatory diagram depicting a feature matrix after compression by the compressing apparatus 101 depicted in FIG. 1.

FIG. 8 is an explanatory diagram depicting a feature matrix after compression by the compressing apparatus 101 depicted in FIG. 1.

FIG. 9 is a configuration diagram depicting a system including another compressing apparatus 101 according to the first embodiment.

FIG. 10 is a configuration diagram depicting a system including a compressing apparatus 101 according to a second embodiment.

FIG. 11 is a hardware configuration diagram depicting hardware of the compressing apparatus 101 according to the second embodiment.

FIG. 12 is an explanatory diagram depicting the difference between a vector of a b-th first left singular matrix U_{b}′ and a vector of a b-th second left singular matrix U_{b}″.

FIG. 13 is a configuration diagram depicting a system including a compressing apparatus 101 according to a third embodiment.

FIG. 14 is a hardware configuration diagram depicting hardware of the compressing apparatus 101 according to the third embodiment.

FIG. 15 is a configuration diagram depicting a system including a compressing apparatus 101 according to a fourth embodiment.

FIG. 16 is a hardware configuration diagram depicting hardware of the compressing apparatus 101 according to the fourth embodiment.

### DESCRIPTION OF EMBODIMENTS

Hereinbelow, embodiments of the present disclosure are explained with reference to the attached figures in order to explain the present disclosure in more detail.

### First Embodiment

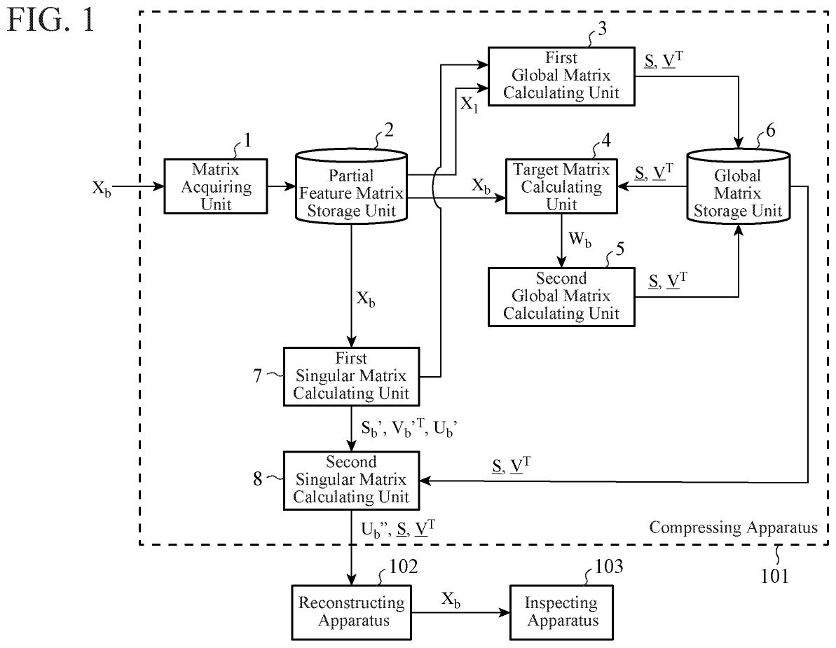

FIG. 1 is a configuration diagram depicting a system including a compressing apparatus 101 according to a first embodiment.

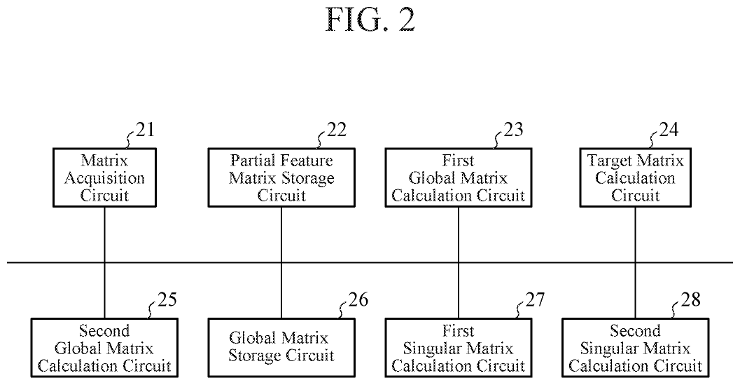

FIG. 2 is a hardware configuration diagram depicting hardware of the compressing apparatus 101 according to the first embodiment.

The system depicted in FIG. 1 includes the compressing apparatus 101, a reconstructing apparatus 102, and an inspecting apparatus 103.

The compressing apparatus 101 depicted in FIG. 1 includes a matrix acquiring unit 1, a partial feature matrix storage unit 2, a first global matrix calculating unit 3, a target matrix calculating unit 4, a second global matrix calculating unit 5, a global matrix storage unit 6, a first singular matrix calculating unit 7, and a second singular matrix calculating unit 8.

The compressing apparatus 101 is an apparatus to compress images. The compression-target images include inspection images, for example. The inspection images are images including objects for inspection.

For example, the matrix acquiring unit 1 is implemented by a matrix acquisition circuit 21 depicted in FIG. 2.

The matrix acquiring unit 1 externally and sequentially acquires a partial feature matrix X_{b} (b=1, . . . , B) for each of a plurality of partial images that are obtained by splitting an image. B is an integer which is equal to or greater than two. For example, the pre-splitting original image of the plurality of partial images is an inspection image. The partial feature matrix X_{b} is a matrix including a feature vector of each partial image.

Every time the partial feature matrix X_{b} is acquired, the matrix acquiring unit 1 causes the partial feature matrix storage unit 2 to store the partial feature matrix X_{b}.

For example, the partial feature matrix storage unit 2 is implemented by a partial feature matrix storage circuit 22 depicted in FIG. 2.

The partial feature matrix storage unit 2 stores the partial feature matrix X_{b} (b=1, . . . , B) acquired by the matrix acquiring unit 1.

The partial feature matrix stored on the partial feature matrix storage unit 2 is any one partial feature matrix X_{b} of partial feature matrices X₁ to X_{b}.

For example, the first global matrix calculating unit 3 is implemented by a first global matrix calculation circuit 23 depicted in FIG. 2.

The first global matrix calculating unit 3 singular-value-decomposes (Singular Value Decomposition: SVD) a first partial feature matrix X₁ which is a partial feature matrix X₁ acquired first by the matrix acquiring unit 1, and calculates a first global singular value matrix S and a first global right singular matrix V^{T}

The first partial feature matrix X₁ is a matrix including one or more singular values s₁ to s_{K}. K is an integer which is equal to or greater than one.

The first global singular value matrix S is the first global singular value matrix including the singular values s₁ to sₖ of the first partial feature matrix X₁.

The first global right singular matrix V^{T} is the first global right singular matrix including right singular vectors vₖ corresponding to singular values sₖ (k=1, . . . , K) of the first partial feature matrix X₁.

The first global matrix calculating unit 3 causes the global matrix storage unit 6 to store the first global singular value matrix S and the first global right singular matrix V^{T}.

It is assumed that, in the compressing apparatus 101 depicted in FIG. 1, the first partial feature matrix X₁ is SVDed by the first singular matrix calculating unit 7. However, this is merely an example. The first global matrix calculating unit 3 may acquire the first partial feature matrix X₁ from the partial feature matrix storage unit 2, SVD the first partial feature matrix X₁, and calculate the first global singular value matrix S and the first global right singular matrix V^{T}

For example, the target matrix calculating unit 4 is implemented by a target matrix calculation circuit 24 depicted in FIG. 2.

The target matrix calculating unit 4 acquires the partial feature matrix X_{b} acquired b-th (b=2, . . . , B) by the matrix acquiring unit 1 from the partial feature matrix storage unit 2. Hereinbelow, the partial feature matrix X_{b} acquired b-th is referred to as a “b-th partial feature matrix X_{b}.”

The target matrix calculating unit 4 acquires a (b-1)-th global singular value matrix S which is the (b-1)-th global singular value matrix, and a (b-1)-th global right singular matrix V^{T} which is the (b-1)-th global right singular matrix V^{T} from the global matrix storage unit 6.

The target matrix calculating unit 4 calculates a b-th target matrix W_{b} including the b-th partial feature matrix X_{b}, the (b-1)-th global singular value matrix S, and the (b-1)-th global right singular matrix V^{T}. The b-th target matrix W_{b} is a matrix to be the b-th singular value decomposition target.

The target matrix calculating unit 4 outputs the b-th target matrix W_{b} to the second global matrix calculating unit 5.

For example, the second global matrix calculating unit 5 is implemented by a second global matrix calculation circuit 25 depicted in FIG. 2.

The second global matrix calculating unit 5 acquires the b-th target matrix W_{b} (b=2, . . . , B) from the target matrix calculating unit 4.

The second global matrix calculating unit 5 SVDes the b-th target matrix W_{b}, and calculates a b-th global singular value matrix S which is the b-th global singular value matrix, and a b-th global right singular matrix V^{T} which is the b-th global right singular matrix.

The b-th global singular value matrix S is a singular value matrix of the b-th target matrix W_{b}, and includes singular values of the b-th target matrix W_{b}. The singular values of the b-th target matrix W_{b} are approximately equal to singular values included in a stacked matrix X₁-b. Because of this, the b-th target matrix W_{b} is a matrix approximately equal to the stacked matrix X₁-b.

The stacked matrix X₁-b is a virtual matrix in which all of the partial feature matrices X₁ to X_{b} having been acquired from the first to the b-th by the matrix acquiring unit 1 are stacked one on another.

The b-th global right singular matrix V^{T} is a right singular matrix of the b-th target matrix W_{b} including the right singular vectors vₖ corresponding to the singular values of the b-th target matrix.

The second global matrix calculating unit 5 causes the global matrix storage unit 6 to store the b-th global singular value matrix S and the b-th global right singular matrix V^{T}

For example, the global matrix storage unit 6 is implemented by a global matrix storage circuit 26 depicted in FIG. 2.

The global matrix storage unit 6 stores the first global singular value matrix S output from the first global matrix calculating unit 3, or the b-th global singular value matrix S output from the second global matrix calculating unit 5.

The global matrix storage unit 6 stores the first global right singular matrix V^{T} output from the first global matrix calculating unit 3, or the b-th global right singular matrix V^{T} output from the second global matrix calculating unit 5.

Every time the b-th global singular value matrix S is output from the second global matrix calculating unit 5, the first global singular value matrix S or the b-th global singular value matrix S having been stored on the global matrix storage unit 6 is updated to the newly output b-th global singular value matrix S. Because of this, only the latest b-th global singular value matrix S is stored on the global matrix storage unit 6.

In addition, every time the b-th global right singular matrix V^{T} is output from the second global matrix calculating unit 5, the first global right singular matrix V^{T} or the b-th global right singular matrix V^{T} having been stored on the global matrix storage unit 6 is updated to the newly output b-th global right singular matrix V^{T}. Because of this, only the latest b-th global right singular matrix V^{T} is stored on the global matrix storage unit 6.

For example, the first singular matrix calculating unit 7 is implemented by a first singular matrix calculation circuit 27 depicted in FIG. 2.

The first singular matrix calculating unit 7 acquires the b-th partial feature matrix X_{b} acquired b-th (b=1, . . . , B) by the matrix acquiring unit 1 from the partial feature matrix storage unit 2.

The first singular matrix calculating unit 7 SVDes the b-th partial feature matrix X_{b}, and calculates a b-th first singular value matrix S_{b}′, a b-th first left singular matrix U_{b}′, and a b-th first right singular matrix V_{b}′T.

The b-th first singular value matrix S_{b}′ is a matrix including the singular values s₁ to s_{K} of the b-th partial feature matrix X_{b}.

The b-th first left singular matrix U_{b}′ is a matrix including left singular vectors uₖ corresponding to the singular values sₖ (k=1, . . . , K) of the b-th partial feature matrix X_{b}.

The b-th first right singular matrix V_{b}′^{T} is a matrix including the right singular vectors vₖ corresponding to the singular values sₖ of the b-th partial feature matrix X_{b}.

The first singular matrix calculating unit 7 outputs the b-th first singular value matrix S_{b}′, the b-th first left singular matrix U_{b}′, and the b-th first right singular matrix V_{b}′^{T} to the second singular matrix calculating unit 8.

For example, the second singular matrix calculating unit 8 is implemented by a second singular matrix calculation circuit 28 depicted in FIG. 2.

The second singular matrix calculating unit 8 acquires the b-th global singular value matrix S and the b-th global right singular matrix V^{T} from the global matrix storage unit 6. b=1, . . . , B.

The second singular matrix calculating unit 8 acquires the b-th first singular value matrix S_{b}′, the b-th first left singular matrix U_{b}′, and the b-th first right singular matrix V_{b}′T from the first singular matrix calculating unit 7.

The second singular matrix calculating unit 8 calculates the b-th second left singular matrix U_{b}″ including the left singular vectors uₖ corresponding to the singular values of the b-th target matrix W_{b} from the b-th global singular value matrix S, the b-th global right singular matrix V^{T}, the b-th first singular value matrix S_{b}′, the b-th first left singular matrix U_{b}′, and the b-th first right singular matrix V_{b}′T.

The second singular matrix calculating unit 8 outputs the b-th second left singular matrix U_{b} ″, the b-th global singular value matrix S, and the b-th global right singular matrix V^{T} to the reconstructing apparatus 102.

The reconstructing apparatus 102 acquires the b-th second left singular matrix U_{b}″, the b-th global singular value matrix S, and the b-th global right singular matrix V^{T} from the second singular matrix calculating unit 8 of the compressing apparatus 101.

The reconstructing apparatus 102 reconstructs the pre-splitting original image of the plurality of partial images on the basis of the b-th second left singular matrix U_{b} ″, the b-th global singular value matrix S, and the b-th global right singular matrix V^{T}.

The reconstructing apparatus 102 outputs the post-reconstruction image to the inspecting apparatus 103.

The inspecting apparatus 103 acquires the post-reconstruction image from the reconstructing apparatus 102.

On the basis of the post-reconstruction image, the inspecting apparatus 103 inspects an object included in the post-reconstruction image.

It is assumed in FIG. 1 that each of the matrix acquiring unit 1, the partial feature matrix storage unit 2, the first global matrix calculating unit 3, the target matrix calculating unit 4, the second global matrix calculating unit 5, the global matrix storage unit 6, the first singular matrix calculating unit 7, and the second singular matrix calculating unit 8 which are constituent elements of the compressing apparatus 101 is implemented by dedicated hardware as depicted in FIG. 2. That is, it is assumed that the compressing apparatus 101 is implemented by the matrix acquisition circuit 21, the partial feature matrix storage circuit 22, the first global matrix calculation circuit 23, the target matrix calculation circuit 24, the second global matrix calculation circuit 25, the global matrix storage circuit 26, the first singular matrix calculation circuit 27, and the second singular matrix calculation circuit 28.

Here, for example, each of the partial feature matrix storage circuit 22 and the global matrix storage circuit 26 is implemented by a Random Access Memory (RAM) or a flash memory.

For example, each of the matrix acquisition circuit 21, the first global matrix calculation circuit 23, the target matrix calculation circuit 24, the second global matrix calculation circuit 25, the first singular matrix calculation circuit 27, and the second singular matrix calculation circuit 28 corresponds to a single circuit, a composite circuit, a programmed processor, a parallel-programmed processor, an Application Specific Integrated Circuit (ASIC), a Field-Programmable Gate Array (FPGA), or a combination of these.

The constituent elements of the compressing apparatus 101 are not limited to those implemented by dedicated hardware, but the compressing apparatus 101 may be implemented by software, firmware or a combination of software and firmware.

The software or the firmware is stored as a program on a memory of a computer. The computer means hardware to execute programs, and, for example, corresponds to a Central Processing Unit (CPU), a Graphics Processing Unit (GPU), a central processor, a processing device, an arithmetic operation device, a microprocessor, a microcomputer, a processor, or a Digital Signal Processor (DSP).

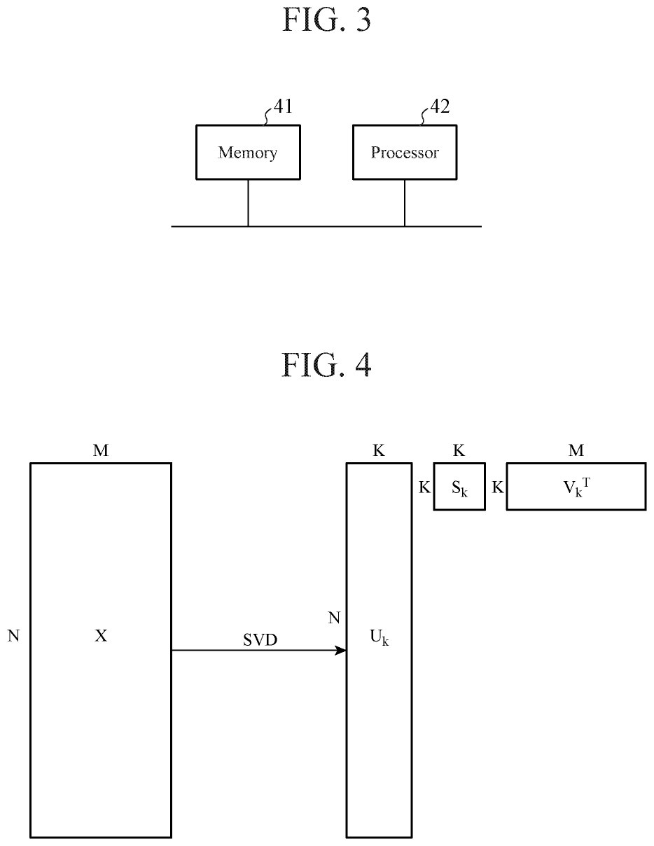

FIG. 3 is a hardware configuration diagram of a computer in a case where the compressing apparatus 101 is implemented by software, firmware, or the like.

In a case where the compressing apparatus 101 is implemented by software, firmware, or the like, each of the partial feature matrix storage unit 2 and the global matrix storage unit 6 is configured on a memory 41 of the computer. A compression program for causing the computer to execute a processing procedure in each of the matrix acquiring unit 1, the first global matrix calculating unit 3, the target matrix calculating unit 4, the second global matrix calculating unit 5, the first singular matrix calculating unit 7, and the second singular matrix calculating unit 8 is stored on the memory 41. Then, a processor 42 of the computer executes the compression program stored on the memory 41.

In addition, FIG. 2 depicts an example in which each of the constituent elements of the compressing apparatus 101 is implemented by dedicated hardware, and FIG. 3 depicts an example in which the compressing apparatus 101 is implemented by software, firmware, or the like. However, these are merely examples, and some constituent elements of the compressing apparatus 101 may be implemented by dedicated hardware, and the remaining constituent elements may be implemented by software, firmware, or the like.

FIG. 4 is an explanatory diagram depicting a feature matrix after compression by the compression method disclosed in Patent Literature 1.

In the feature matrix compression method disclosed in Patent Literature 1, first, a processing apparatus which is not depicted externally acquires a feature matrix X representing features of an image including an object, and stores the feature matrix X on a memory which is not depicted. In the example in FIG. 4, the data size of the feature matrix X is M×N, and M<N. Each of M and Nis an integer which is equal to or greater than two. The feature matrix X includes N feature vectors n₁ to n_{N}.

The processing apparatus compresses the feature matrix X by SVDing the feature matrix X.

Specifically, as depicted in FIG. 4, by SVDing the feature matrix X, the processing apparatus calculates the singular value matrix S including the one or more singular values s₁ to sₖ included in the feature matrix X, a left singular matrix U including the left singular vector uₖ corresponding to each of the singular values sₖ (k=1, . . . , M), and the right singular matrix V^{T} including the right singular vector vₖ corresponding to each of the singular values sₖ. K is an integer which is equal to or greater than one, and K<<M.

The data size of the singular value matrix S is K×K, the data size of the left singular matrix U is K×N, and the data size of right singular matrix VTis M×K.

Next, an operation performed by the compressing apparatus 101 depicted in FIG. 1 is explained.

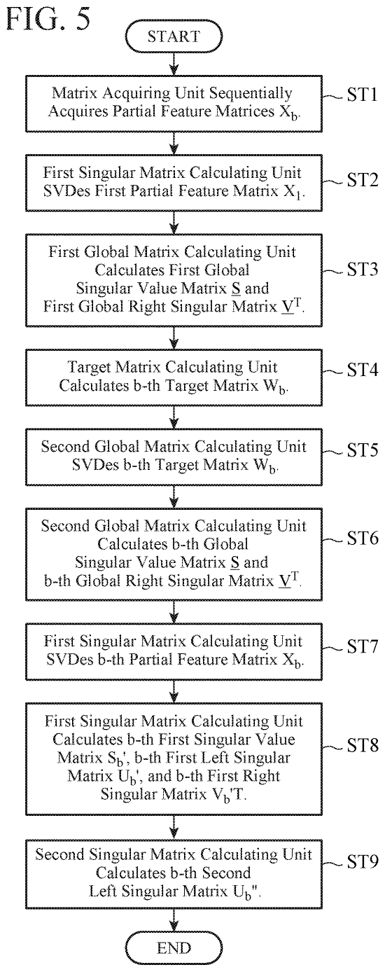

FIG. 5 is a flowchart depicting a compression method which is a processing procedure performed by the compressing apparatus 101.

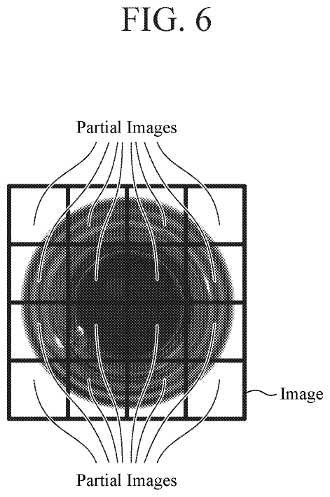

It is assumed that, in the compressing apparatus 101 depicted in FIG. 1, an image has been split into a plurality of partial images as depicted in FIG. 6.

FIG. 6 is an explanatory diagram depicting the plurality of partial images included in the image.

FIG. 6 depicts an example in which an image is split into sixteen partial images, and the sizes of the sixteen partial images are the same. However, this is merely an example, and the number of split images is not limited to sixteen. In addition, the sizes of the plurality of split images are not necessarily the same.

It is assumed that the number of partial images is B in the compressing apparatus 101 depicted in FIG. 1, for convenience of explanation. B is an integer which is equal to or greater than two.

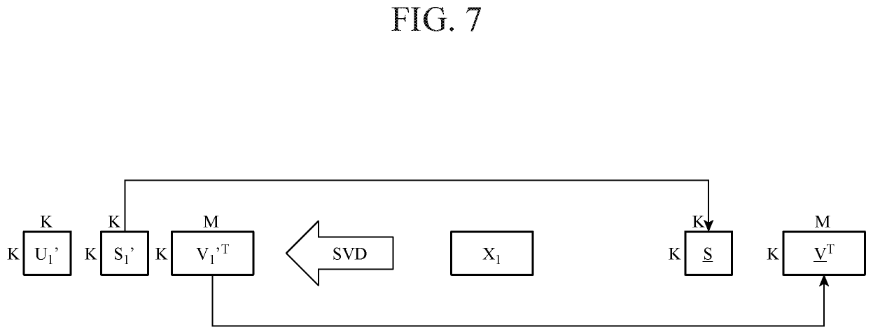

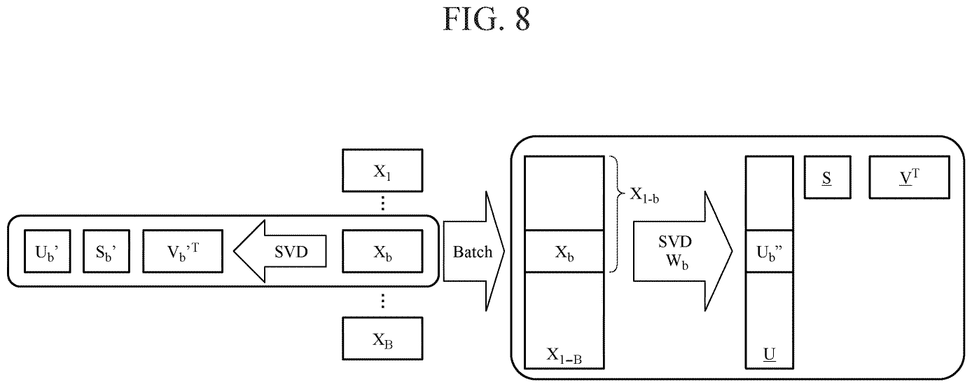

Each of FIG. 7 and FIG. 8 is an explanatory diagram depicting a feature matrix after compression by the compressing apparatus 101 depicted in FIG. 1.

The matrix acquiring unit 1 externally and sequentially acquires the partial feature matrix X_{b} (b=1, . . . , B) for each of B partial images (step ST1 in FIG. 5).

Every time the partial feature matrix X_{b} is acquired, the matrix acquiring unit 1 causes the partial feature matrix storage unit 2 to store the partial feature matrix X_{b}.

The partial feature matrix stored on the partial feature matrix storage unit 2 is any one partial feature matrix X_{b} of partial feature matrices X₁ to X_{b}.

The data size of the partial feature matrix X_{b} is one B-th of the data size of the feature matrix X.

In the compressing apparatus depicted in FIG. 1, the matrix acquiring unit 1 sequentially acquires the partial feature matrix X_{b} (b=1, . . . , B). However, this is merely an example, and the matrix acquiring unit 1 may acquire each partial image, and calculate the partial feature matrix X_{b} for each partial image. The method of calculating the partial feature matrix X_{b} is not particularly limited, but, for example, there is a method in which a partial image is given to a Convolutional Neural Network (CNN), and a feature vector of the partial image is acquired from the CNN. The CNN is a learning model that has been trained with feature vectors of images.

The first singular matrix calculating unit 7 acquires the first partial feature matrix X₁ which is a partial feature matrix acquired first by the matrix acquiring unit 1 from the partial feature matrix storage unit 2.

As depicted in FIG. 7, the first singular matrix calculating unit 7 SVDes the first partial feature matrix X₁ (step ST2 in FIG. 5).

Specifically, as represented by the following Formula (1), the first singular matrix calculating unit 7 truncated-SVDes the first partial feature matrix X₁, and outputs a result of the SVD to the first global matrix calculating unit 3.

$${X}_{1} ∼ {U}_{1}^{′} {S}_{1}^{′} {V}_{1}^{′ T} \qquad ( 1 )$$

In Formula (1), “~” is a mathematical symbol representing truncated-SVD.

The truncated-SVD is one type of SVD, and is an approach for computing only the top singular values s₁ to s_{K} among M singular values s₁ to s_{M} included in the first partial feature matrix X₁, and truncating the remaining singular values. The top singular values s₁ to sₖ are singular values related to important features of the image in a plurality of features of the image.

The first global matrix calculating unit 3 acquires the result of the SVD from the first singular matrix calculating unit 7.

On the basis of the result of the SVD, the first global matrix calculating unit 3 calculates the first singular value matrix S₁′ as the first global singular value matrix S, and calculates the first right singular matrix V₁′^{T} as the first global right singular matrix V^{T} (step ST3 in FIG. 5).

The first first singular value matrix s₁′ is a matrix including the top K singular values s₁ to sₖ among the M singular values s₁ to s_{M} included in the first partial feature matrix X₁. The first first right singular matrix V₁′^{T} is a matrix including the right singular vectors vₖ corresponding to the singular values sₖ (k=1, . . . , K) included in the first partial feature matrix X₁.

Hereinbelow, the one or more singular values included in the first global singular value matrix S are denoted as s₁ to s_{K}.

Note that the first global matrix calculating unit 3 does not calculate a first left singular matrix U₁′ including the left singular vectors uₖ corresponding to the singular values sₖ (k=1, . . . , K) included in the first partial feature matrix X₁.

The first global matrix calculating unit 3 causes the global matrix storage unit 6 to store the first global singular value matrix S.

The first global matrix calculating unit 3 causes the global matrix storage unit 6 to store the first global right singular matrix V^{T}

The target matrix calculating unit 4 acquires the b-th partial feature matrix X_{b} which is a partial feature matrix acquired b-th (b=2, . . . , B) by the matrix acquiring unit 1 from the partial feature matrix storage unit 2.

The target matrix calculating unit 4 acquires the global singular value matrix S calculated last time from the global matrix storage unit 6.

Specifically, when having acquired a second partial feature matrix X2 acquired second by the matrix acquiring unit 1 from the partial feature matrix storage unit 2, the target matrix calculating unit 4 acquires the first global singular value matrix S calculated by the first global matrix calculating unit 3 from the global matrix storage unit 6.

When having acquired the b-th partial feature matrix X_{b} acquired b-th (b=3, . . . , B) by the matrix acquiring unit 1 from the partial feature matrix storage unit 2, the target matrix calculating unit 4 acquires the (b-1)-th global singular value matrix S calculated by the second global matrix calculating unit 5 from the global matrix storage unit 6.

The (b-1)-th global singular value matrix S is a matrix including the singular values s₁ to s_{K} approximately equal to a plurality of singular values included in a stacked matrix X_{1-(b-1)} which is a matrix in which partial feature matrices X₁ to X_{b-1} are stacked one on another.

As represented by the following Formula (2), the target matrix calculating unit 4 calculates the b-th target matrix W_{b} which is a matrix of the b-th singular value decomposition target including the b-th partial feature matrix X_{b}, the (b-1)-th global singular value matrix S, and the (b-1)-th global right singular matrix V^{T} (step ST4 in FIG. 5).

$$\begin{matrix}{W}_{b} = [ {\underline{V}}^{T} \underline{S} , {X}_{b}^{T} ] \\ = [ {\underline{V}}^{T} diag ( {\underline{s}}_{1} … {\underline{s}}_{K} ) , {X}_{b}^{T} ]\end{matrix} \qquad ( 2 )$$

In Formula (2), diag is a mathematical symbol representing that the (b-1)-th global singular value matrix S is a diagonal matrix. T is a mathematical symbol representing a transpose.

The target matrix calculating unit 4 outputs the b-th target matrix W_{b} to the second global matrix calculating unit 5.

The second global matrix calculating unit 5 acquires the b-th target matrix W_{b} (b=2, . . . , B) from the target matrix calculating unit 4.

As depicted in FIG. 8, the second global matrix calculating unit 5 SVDes the b-th target matrix W_{b} (step ST5 in FIG. 5).

Specifically, as represented by the following Formula (3), the second global matrix calculating unit 5 truncated-SVDes the b-th target matrix W_{b}, and calculates the b-th global singular value matrix S which is the b-th global singular value matrix, and the b-th global right singular matrix V^{T} which is the b-th global right singular matrix (step ST6 in FIG. 5).

$${W}_{b} ∼ \underline{V} \underline{S} {\underline{U}}^{T} \qquad ( 3 )$$

In the truncated-SVD by the second global matrix calculating unit 5, the second global matrix calculating unit 5 calculates the b-th global singular value matrix S and the b-th global right singular matrix V^{T}, but does not calculate the global left singular matrix U.

The b-th target matrix W_{b} is a matrix including not only the b-th partial feature matrix X_{b}, but the (b-1)-th global singular value matrix S and the (b-1)-th global right singular matrix V^{T} Because of this, as depicted in FIG. 8, truncated-SVDing the b-th target matrix W_{b} is equivalent to truncated-SVDing the stacked matrix X₁-b which is a matrix in which all of the partial feature matrices X₁ to X_{b} are stacked one on another. Because of this, the b-th global singular value matrix S is a matrix including the singular values s₁ to s_{K} approximately equal to one or more singular values included in the stacked matrix X₁-b. In addition, the b-th global right singular matrix V^{T} is a matrix including the right singular vectors vₖ corresponding to the singular values sₖ (k=1, . . . , K) approximately equal to the respective singular values included in the stacked matrix X₁-b.

The second global matrix calculating unit 5 causes the global matrix storage unit 6 to overwrite and save the b-th global singular value matrix S and the b-th global right singular matrix V^{T}

Thereby, since the (b-1)-th global singular value matrix S having been stored earlier on the global matrix storage unit 6 is updated to the b-th global singular value matrix S output from the second global matrix calculating unit 5, only the b-th global singular value matrix S which is the latest global singular value matrix S is stored on the global matrix storage unit 6.

In addition, since the (b-1)-th global right singular matrix V^{T} having been stored earlier on the global matrix storage unit 6 is updated to the b-th global right singular matrix V^{T} output from the second global matrix calculating unit 5, only the b-th global right singular matrix V^{T} which is the latest global right singular matrix V^{T} is stored on the global matrix storage unit 6.

As mentioned above, the first singular matrix calculating unit 7 acquires the first partial feature matrix X₁ acquired first by the matrix acquiring unit 1 from the partial feature matrix storage unit 2.

As depicted in FIG. 7, the first singular matrix calculating unit 7 SVDes the first partial feature matrix X₁.

Specifically, as represented by Formula (1), the first singular matrix calculating unit 7 truncated-SVDs the first partial feature matrix X₁, and calculates the first first singular value matrix S₁′, the first first left singular matrix U₁′, and the first first right singular matrix V₁′^{T}.

The first first left singular matrix U₁′ is a matrix including the left singular vectors uₖ corresponding to the top K singular values sₖ (k=1, . . . , K) among the M singular values s₁ to S_{M} included in the first partial feature matrix X₁.

The first singular matrix calculating unit 7 acquires the b-th partial feature matrix X_{b} which is a partial feature matrix acquired b-th (b=2, . . . , B) by the matrix acquiring unit 1 from the partial feature matrix storage unit 2.

As depicted in FIG. 8, the first singular matrix calculating unit 7 SVDes the b-th partial feature matrix X_{b} (step ST7 in FIG. 5).

Specifically, as represented by the following Formula (4), the first singular matrix calculating unit 7 calculates the b-th first singular value matrix S_{b}′, the b-th first left singular matrix U_{b}′, and the b-th first right singular matrix V_{b}′^{T} by truncated-SVDing the b-th partial feature matrix X_{b} (step ST8 in FIG. 5).

The b-th first singular value matrix S_{b}′ is a matrix including the top K singular values s₁ to sₖ among the M singular values s₁ to S_{M} included in the b-th partial feature matrix X_{b}. The b-th first left singular matrix U_{b}′ is a matrix including the left singular vectors uₖ corresponding to the singular values sₖ (k=1, . . . , K) included in the b-th partial feature matrix X_{b}. The b-th first right singular matrix V_{b}′^{T} is a matrix including right singular vectors vi to v_{K} corresponding to the singular values sₖ included in the b-th partial feature matrix X_{b}.

$${X}_{b} ∼ {U}_{b}^{′} {S}_{b}^{′} {V}_{b}^{′ T} \qquad ( 4 )$$

The first singular matrix calculating unit 7 outputs the b-th (b=1, . . . , B) first singular value matrix S_{b}′, the b-th first left singular matrix U_{b}′, and the b-th first right singular matrix V_{b}′^{T} to the second singular matrix calculating unit 8.

The second singular matrix calculating unit 8 acquires the b-th global singular value matrix S which is the b-th (b=1, . . . , B) global singular value matrix S, and the b-th global right singular matrix V^{T} which is the b-th global right singular matrix V^{T} from the global matrix storage unit 6.

The second singular matrix calculating unit 8 acquires the b-th first singular value matrix S_{b}′, the b-th first left singular matrix U_{b}′, and the b-th first right singular matrix V_{b}′^{T} from the first singular matrix calculating unit 7.

On the basis of the following Formula (5), the second singular matrix calculating unit 8 calculates the b-th second left singular matrix U_{b}″ from the b-th global singular value matrix S, the b-th global right singular matrix V^{T}, the b-th first singular value matrix S_{b}′, the b-th first left singular matrix U_{b}′, and the b-th first right singular matrix V_{b}′^{T} (step ST9 in FIG. 5).

The b-th second left singular matrix U_{b}″ is a matrix including the left singular vectors uₖ corresponding to the singular values sₖ (k=1, . . . , K) included in the b-th partial feature matrix X_{b}.

$${U}_{b}^{″} \underline{S} {\underline{V}}^{T} = {U}_{b}^{′} {S}_{b}^{′} {V}_{b}^{′ T} \qquad ( 5 )$$

The second singular matrix calculating unit 8 outputs the b-th second left singular matrix U_{b} ″, the b-th global singular value matrix S, and the b-th global right singular matrix V^{T} to the reconstructing apparatus 102.

Hereinbelow, a process of calculation of the b-th second left singular matrix U_{b}″ by the second singular matrix calculating unit 8 is explained specifically.

First, as represented by the following Formula (6), the second singular matrix calculating unit 8 multiplies both sides of Formula (5) by V.

$$\begin{matrix}{U}_{b}^{″} \underline{S} {\underline{V}}^{T} \underline{V} = {U}_{b}^{′} {S}_{b}^{′} {V}_{b}^{′ T} \underline{V} \\ ↓ \\ {U}_{b}^{″} \underline{S} = {U}_{b}^{′} {S}_{b}^{′} {V}_{b}^{′ T} \underline{V}\end{matrix} \qquad ( 6 )$$

Next, as represented by the following Formula (7), the second singular matrix calculating unit 8 calculates an inverse matrix S⁻¹ of the b-th global singular value matrix S.

$$\begin{matrix}\underline{S} = diag ( {\underline{s}}_{1} … {\underline{s}}_{K} ) \\ ↓ \\ {\underline{S}}^{- 1} = diag ( 1 / {\underline{s}}_{1} … 1 / {\underline{s}}_{K} )\end{matrix} \qquad ( 7 )$$

Next, as represented by the following Formula (8), the second singular matrix calculating unit 8 calculates the b-th second left singular matrix U_{b}″ by multiplying both sides of Formula (6) by the inverse matrix S⁻¹.

$$\begin{matrix}{U}_{b}^{″} \underline{S} {\underline{S}}^{- 1} = {U}_{b}^{′} {S}_{b}^{′} {V}_{b}^{′ T} \underline{V} {\underline{S}}^{- 1} \\ ↓ \\ {U}_{b}^{″} = {U}_{b}^{′} {S}_{b}^{′} {V}_{b}^{′ T} \underline{V} {\underline{S}}^{- 1}\end{matrix} \qquad ( 8 )$$

The reconstructing apparatus 102 acquires the b-th second left singular matrix U_{b} ″, the b-th global singular value matrix S, and the b-th global right singular matrix V^{T} from the second singular matrix calculating unit 8 of the compressing apparatus 101.

The reconstructing apparatus 102 reconstructs the pre-splitting original image of the plurality of partial images on the basis of the b-th second left singular matrix U_{b}″, the b-th global singular value matrix S, and the b-th global right singular matrix V^{T}

Specifically, the reconstructing apparatus 102 substitutes the b-th second left singular matrix U_{b} ″, the b-th global singular value matrix S, and the b-th global right singular matrix V^{T} into Formula (5) to calculate U_{b}′S_{b}′V₀′^{T} which is the right-hand side of Formula (5).

That is, the reconstructing apparatus 102 calculates U_{b}′S_{b}′V_{b}′^{T} as the b-th partial feature matrix X_{b}.

After the completion of the calculation of b-th partial feature matrices X₁ to X_{B}, the reconstructing apparatus 102 reconstructs the feature matrix X of an inspection image including the b-th partial feature matrices X₁ to X_{B}. The completion of the reconstruction of the feature matrix X of the inspection image is equivalent to completion of the reconstruction of the inspection image. It is assumed here that, when reconstructing the inspection image, the reconstructing apparatus 102 knows in advance to which position in the inspection image a partial image related to the b-th partial feature matrix X_{b} (b=1, . . . , B) corresponds. In addition, it is assumed that the reconstructing apparatus 102 also knows in advance the sequence of acquisition of the b-th partial feature matrix X_{b} by the matrix acquiring unit 1.

Specifically, if the matrix acquiring unit 1 externally acquires partial feature matrix information when acquiring the b-th partial feature matrix X_{b}, the reconstructing apparatus 102 acquires the partial feature matrix information from the compressing apparatus 101. For example, the partial feature matrix information includes identification information for identifying the b-th partial feature matrix X_{b}, sequence information representing the sequence of acquisition of the b-th partial feature matrix X_{b} by the matrix acquiring unit 1, and positional information representing the position of the b-th partial feature matrix X_{b} in the inspection image. The reconstructing apparatus 102 calculates the b-th partial feature matrix X_{b} in the acquisition sequence represented by the sequence information, and, when the calculation of the b-th partial feature matrices X₁ to X_{B} is completed, reconstructs the feature matrix X of the inspection image including the b-th partial feature matrices X₁ to X_{B} on the basis of the positional information.

The reconstructing apparatus 102 outputs the feature matrix X of the inspection image to the inspecting apparatus 103.

The inspecting apparatus 103 acquires the feature matrix X of the inspection image as a post-reconstruction image from the reconstructing apparatus 102.

On the basis of the feature matrix X, the inspecting apparatus 103 inspects an object included in the inspection image.

Since processes themselves of inspecting an object included in the inspection image on the basis of the feature matrix X are known technologies, a process of inspecting an object is explained here simply.

The inspecting apparatus 103 has stored thereon one or more feature vectors included in a feature matrix of a normal object. In a case where such feature vectors are not stored, for example, the inspecting apparatus 103 may externally acquire feature vectors.

The inspecting apparatus 103 calculates each of differences between the one or more feature vectors included in the feature matrix of the normal object, and one or more feature vectors included in the feature matrix X.

If all of the calculated differences are within a threshold, the inspecting apparatus 103 determines that the object included in the inspection image is normal. The threshold may be stored on an internal memory of the inspecting apparatus 103 or may be given externally.

If one or more differences among the calculated differences are equal to or greater than the threshold, the inspecting apparatus 103 determines that the object included in the inspection image is abnormal.

In the first embodiment above, the compressing apparatus 101 is configured to include: the matrix acquiring unit 1 to sequentially acquire a partial feature matrix for each of a plurality of partial images that are obtained by splitting an image; and the first global matrix calculating unit 3 to calculate a first global singular value matrix which is the first global singular value matrix and includes singular values of a first partial feature matrix, and a first global right singular matrix which is the first global right singular matrix and includes right singular vectors corresponding to the singular values of the first partial feature matrix, by singular-value-decomposing the first partial feature matrix which is a partial feature matrix acquired first by the matrix acquiring unit 1. In addition, the compressing apparatus 101 includes: the target matrix calculating unit 4 to calculate a b-th target matrix which is a matrix of the b-th singular value decomposition target and includes a b-th partial feature matrix which is a partial feature matrix acquired b-th (b is an integer which is equal to or greater than two) by the matrix acquiring unit 1, a (b-1)-th global singular value matrix, and a (b-1)-th global right singular matrix; and the second global matrix calculating unit 5 to singular-value-decompose the b-th target matrix calculated by the target matrix calculating unit 4, calculate, as a b-th global singular value matrix, a singular value matrix of the b-th target matrix including singular values of the b-th target matrix, and calculate, as a b-th global right singular matrix, a right singular matrix of the b-th target matrix including right singular vectors corresponding to the singular values of the b-th target matrix. Accordingly, it becomes possible for the compressing apparatus 101 to compress feature matrices simply by storing parts of the feature matrices on a memory.

In addition, the compressing apparatus 101 includes the first singular matrix calculating unit 7 to singular-value-decompose the b-th partial feature matrix acquired b-th by the matrix acquiring unit 1, and calculate a b-th first singular value matrix including singular values of the b-th partial feature matrix, the b-th first left singular matrix including left singular vectors corresponding to the singular values of the b-th partial feature matrix, and the b-th first right singular matrix including right singular vectors corresponding to the singular values of the b-th partial feature matrix; and the second singular matrix calculating unit 8 to calculate a b-th second left singular matrix including left singular vectors corresponding to the singular values of the b-th target matrix, from the b-th global singular value matrix calculated by the second global matrix calculating unit 5, the b-th global right singular matrix calculated by the second global matrix calculating unit 5, the b-th first singular value matrix calculated by the first singular matrix calculating unit 7, the b-th first left singular matrix calculated by the first singular matrix calculating unit 7, and the b-th first right singular matrix calculated by the first singular matrix calculating unit 7. Accordingly, the compressing apparatus can compress feature matrices simply by storing parts of the feature matrices on the memory.

In the compressing apparatus depicted in FIG. 1, each of the second global matrix calculating unit 5 and the first singular matrix calculating unit 7 truncated-SVDes matrices. As long as matrices can be compressed, SVD is not necessarily truncated-SVD, and, for example, each of the second global matrix calculating unit 5 and the first singular matrix calculating unit 7 may economy-SVD matrices.

In addition, there is increment-SVD as one type of SVD. Even in a case where increment-SVD is performed, matrices can be compressed. That is, the second left singular matrix U_{b}″ is obtained by increment-SVDing the partial feature matrix X_{b}. Note that as the value of b increases, and the value of b approaches the value of B, the number of left singular vectors included in the second left singular matrix U_{b}″ increases, and the number of rows of the second left singular matrix U_{b}″ increases. Because of this, as the value of b increases, and the value of b approaches the value of B, the processing time of increment-SVD increases.

In contrast with this, the second global matrix calculating unit 5 calculates the b-th global singular value matrix S and the b-th global right singular matrix V^{T} by truncated-SVDing the b-th target matrix W_{b}, but does not perform calculation of the b-th global right singular matrix which is a right singular matrix of the b-th target matrix including the right singular vectors corresponding to the singular values of the b-th target matrix W_{b}. Because of this, even when the value of b increases, and the value of b approaches the value of B, the processing time of SVD does not increase unlike increment-SVD.

The compressing apparatus 101 depicted in FIG. 1 includes the matrix acquiring unit 1, the partial feature matrix storage unit 2, the first global matrix calculating unit 3, the target matrix calculating unit 4, the second global matrix calculating unit 5, the global matrix storage unit 6, the first singular matrix calculating unit 7, and the second singular matrix calculating unit 8. However, this is merely an example, and, for example, the compressing apparatus 101 may include the matrix acquiring unit 1, the partial feature matrix storage unit 2, the first global matrix calculating unit 3, the target matrix calculating unit 4, the second global matrix calculating unit 5, and the global matrix storage unit 6, and each of the first singular matrix calculating unit 7 and the second singular matrix calculating unit 8 may be provided outside the compressing apparatus 101. Examples of the outside of the compressing apparatus 101 include a cloud.

In a case where, for example, each of the first singular matrix calculating unit 7 and the second singular matrix calculating unit 8 is provided on a cloud, the compressing apparatus 101 transmits, to the cloud, the b-th partial feature matrix X_{b} (b=2, . . . , B) stored on the partial feature matrix storage unit 2, and the b-th global singular value matrix S and the b-th global right singular matrix V^{T} stored on the global matrix storage unit 6.

Thereby, the first singular matrix calculating unit 7 provided on the cloud calculates the b-th first singular value matrix S_{b}′, the b-th first left singular matrix U_{b}′, and the b-th first right singular matrix V_{b}′^{T}, and the second singular matrix calculating unit 8 provided on the cloud calculates the b-th second left singular matrix U_{b} ″.

The compressing apparatus 101 acquires the b-th second left singular matrix U_{b}″, the b-th global singular value matrix S, and the b-th global right singular matrix V^{T} from the second singular matrix calculating unit 8 provided on the cloud.

Then, the compressing apparatus 101 outputs the b-th second left singular matrix U_{b} ″, the b-th global singular value matrix S, and the b-th global right singular matrix V^{T} to the reconstructing apparatus 102.

The compressing apparatus in a case where each of the first singular matrix calculating unit 7 and the second singular matrix calculating unit 8 is provided outside the compressing apparatus 101 experiences a lower processing load than the compressing apparatus 101 depicted in FIG. 1 does.

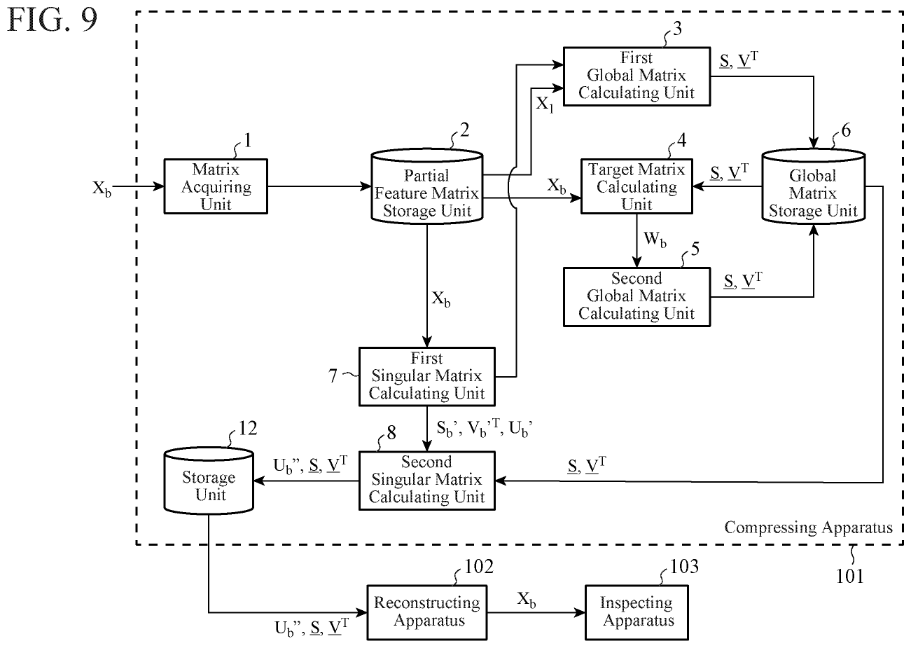

In the compressing apparatus 101 depicted in FIG. 1, the second singular matrix calculating unit 8 outputs the b-th second left singular matrix U_{b}″, the b-th global singular value matrix S, and the b-th global right singular matrix V^{T} to the reconstructing apparatus 102. However, this is merely an example, and, as depicted in FIG. 9, the compressing apparatus 101 may include a storage unit 12 to store the b-th second left singular matrix U_{b}″ calculated by the second singular matrix calculating unit 8, the b-th global singular value matrix S calculated by the second global matrix calculating unit 5, and the b-th global right singular matrix V^{T} calculated by the second global matrix calculating unit 5. FIG. 9 is a configuration diagram depicting a system including another compressing apparatus 101 according to the first embodiment.

In this case, when reconstructing a pre-splitting original image of a plurality of partial images, the reconstructing apparatus 102 acquires the b-th second left singular matrix U_{b} ″, the b-th global singular value matrix S, and the b-th global right singular matrix V^{T} from the storage unit 12.

### Second Embodiment

In a compressing apparatus 101 explained in a second embodiment, a second singular matrix calculating unit 9 acquires a b-th rotation matrix R_{b} for rotating the b-th first left singular matrix U_{b}′, and calculates the b-th second left singular matrix U_{b}″ from the b-th rotation matrix R_{b} and the b-th first left singular matrix U_{b}′.

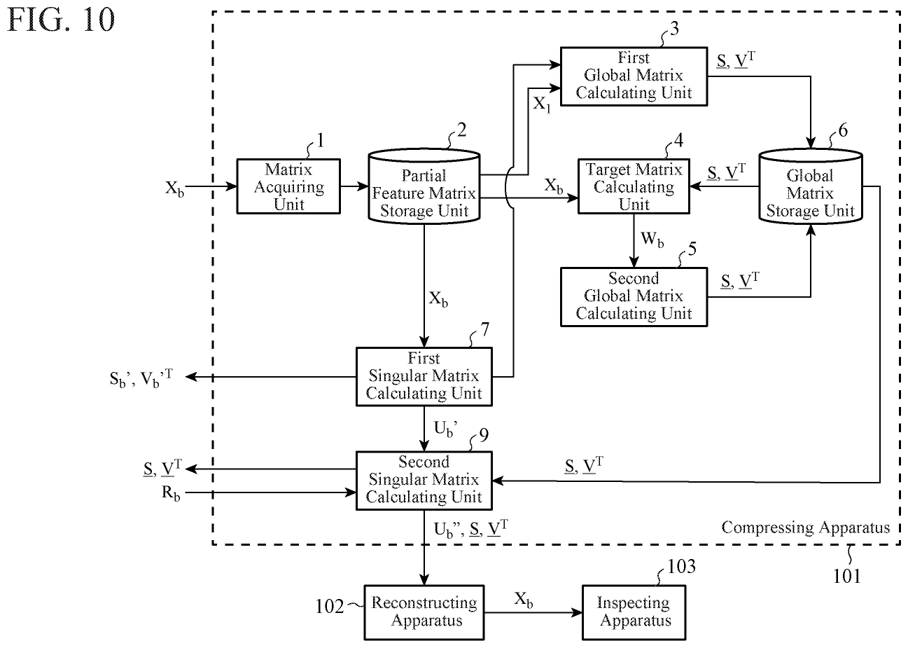

FIG. 10 is a configuration diagram depicting a system including the compressing apparatus 101 according to the second embodiment. Since reference signs in FIG. 10 that are identical to those in FIG. 1 and FIG. 9 represent identical or equivalent portions, detailed explanations thereof are omitted.

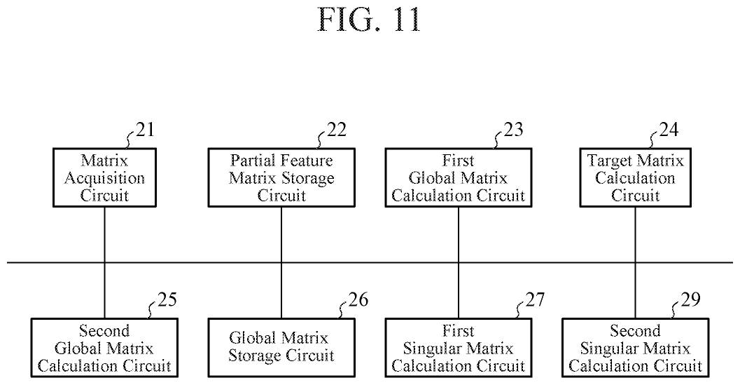

FIG. 11 is a hardware configuration diagram depicting hardware of the compressing apparatus 101 according to the second embodiment. Since reference signs in FIG. 11 that are identical to those in FIG. 2 represent identical or equivalent portions, detailed explanations thereof are omitted.

The compressing apparatus 101 depicted in FIG. 10 includes a matrix acquiring unit 1, a partial feature matrix storage unit 2, a first global matrix calculating unit 3, a target matrix calculating unit 4, a second global matrix calculating unit 5, a global matrix storage unit 6, a first singular matrix calculating unit 7, and the second singular matrix calculating unit 9. However, this is merely an example, and, for example, the compressing apparatus 101 may include the matrix acquiring unit 1, the partial feature matrix storage unit 2, the first global matrix calculating unit 3, the target matrix calculating unit 4, the second global matrix calculating unit 5, and the global matrix storage unit 6, and each of the first singular matrix calculating unit 7 and the second singular matrix calculating unit 9 may be provided outside the compressing apparatus 101. Examples of the outside of the compressing apparatus 101 include a cloud.

For example, the second singular matrix calculating unit 9 is implemented by a second singular matrix calculation circuit 29 depicted in FIG. 11.

The second singular matrix calculating unit 9 acquires the b-th (b=1, . . . , B) first left singular matrix U_{b}′ from the first singular matrix calculating unit 7, and acquires the b-th rotation matrix R_{b} from a processing apparatus which is not depicted.

The rotation matrix R_{b} is calculated from a b-th global singular value matrix S, a b-th global right singular matrix V^{T}, the b-th first singular value matrix S_{b}′, and the b-th first right singular matrix V_{b}′^{T}.

The second singular matrix calculating unit 9 calculates the b-th second left singular matrix U_{b}″ from the b-th rotation matrix R_{b} and the b-th first left singular matrix U_{b}′.

The b-th second left singular matrix U_{b}″ is a matrix including left singular vectors uₖ corresponding to singular values sₖ included in a b-th target matrix W_{b}.

The second singular matrix calculating unit 9 outputs the b-th second left singular matrix U_{b} ″, the b-th global singular value matrix S, and the b-th global right singular matrix V^{T} to a reconstructing apparatus 102.

It is assumed in FIG. 10 that each of the matrix acquiring unit 1, the partial feature matrix storage unit 2, the first global matrix calculating unit 3, the target matrix calculating unit 4, the second global matrix calculating unit 5, the global matrix storage unit 6, the first singular matrix calculating unit 7, and the second singular matrix calculating unit 9 which are constituent elements of the compressing apparatus 101 is implemented by dedicated hardware as depicted in FIG. 11. That is, it is assumed that the compressing apparatus 101 is implemented by a matrix acquisition circuit 21, a partial feature matrix storage circuit 22, a first global matrix calculation circuit 23, a target matrix calculation circuit 24, a second global matrix calculation circuit 25, a global matrix storage circuit 26, a first singular matrix calculation circuit 27, and the second singular matrix calculation circuit 29.

For example, each of the matrix acquisition circuit 21, the first global matrix calculation circuit 23, the target matrix calculation circuit 24, the second global matrix calculation circuit 25, the first singular matrix calculation circuit 27, and the second singular matrix calculation circuit 29 corresponds to a single circuit, a composite circuit, a programmed processor, a parallel-programmed processor, an ASIC, or an FPGA, or a combination of these.

The constituent elements of the compressing apparatus 101 are not limited to those implemented by dedicated hardware, but the compressing apparatus 101 may be implemented by software, firmware or a combination of software and firmware.

In a case where the compressing apparatus 101 is implemented by software, firmware, or the like, each of the partial feature matrix storage unit 2 and the global matrix storage unit 6 is configured on the memory 41 depicted in FIG. 3 of the computer. A compression program for causing the computer to execute a processing procedure in each of the matrix acquiring unit 1, the first global matrix calculating unit 3, the target matrix calculating unit 4, the second global matrix calculating unit 5, the first singular matrix calculating unit 7, and the second singular matrix calculating unit 9 is stored on the memory 41. Then, the processor 42 depicted in FIG. 3 executes the compression program stored on the memory 41.

In addition, FIG. 11 depicts an example in which each of the constituent elements of the compressing apparatus 101 is implemented by dedicated hardware, and FIG. 3 depicts an example in which the compressing apparatus 101 is implemented by software, firmware, or the like. However, these are merely examples, and some constituent elements of the compressing apparatus 101 may be implemented by dedicated hardware, and the remaining constituent elements may be implemented by software, firmware, or the like.

Next, an operation performed by the compressing apparatus 101 depicted in FIG. 10 is explained. Note that those other than the second singular matrix calculating unit 9 are similar to their counterparts in the compressing apparatus 101 depicted in FIG. 1. Because of this, here, an operation performed by the second singular matrix calculating unit 9 is explained mainly.

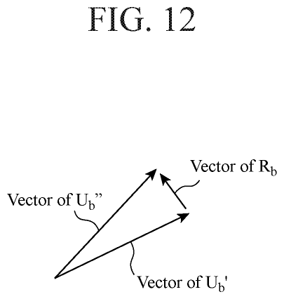

As depicted in FIG. 12, there is a difference between a vector of the b-th (b=1, . . . , B) first left singular matrix U_{b}′, and a vector of the b-th second left singular matrix U_{b}″, and the difference is equivalent to a vector of the b-th rotation matrix R_{b}. Accordingly, by rotating the b-th first left singular matrix U_{b}′ by the b-th rotation matrix R_{b}, the b-th first left singular matrix U_{b}′ is caused to match the b-th second left singular matrix U_{b} ″.

FIG. 12 is an explanatory diagram depicting the difference between the vector of the b-th first left singular matrix U_{b}′ and the vector of the b-th second left singular matrix U_{b}″.

The first singular matrix calculating unit 7 outputs, to the processing apparatus which is not depicted, the calculated b-th first singular value matrix S_{b}′, and the calculated b-th first right singular matrix V_{b}′^{T}. For example, the processing apparatus which is not depicted is provided on a cloud.

The second singular matrix calculating unit 9 outputs, to the processing apparatus which is not depicted, the b-th global singular value matrix S and the b-th global right singular matrix V^{T} that are stored on the global matrix storage unit 6.

As depicted in the following Formula (9), the processing apparatus which is not depicted calculates the b-th rotation matrix R_{b} for rotating the b-th first left singular matrix U_{b}′ from the b-th global singular value matrix S, the b-th global right singular matrix V^{T}, the b-th first singular value matrix S_{b}′, and the b-th first right singular matrix V_{b}′^{T}. The data size of the rotation matrix R_{b} is K×K.

$$\begin{matrix}{R}_{b} = {S}_{b}^{′} {V}_{b}^{′ T} {\underline{V}}^{T} {\underline{S}}^{- 1} \\ = diag ( {s}_{1} … {s}_{K} ) {V}_{b}^{′ T} {\underline{V}}^{T} diag ( 1 / {\underline{s}}_{1} … 1 / {\underline{s}}_{K} )\end{matrix} \qquad ( 9 )$$

The processing apparatus which is not depicted outputs the b-th rotation matrix R_{b} to the second singular matrix calculating unit 9.

The second singular matrix calculating unit 9 acquires the b-th first left singular matrix U_{b}′ from the first singular matrix calculating unit 7, and acquires the b-th rotation matrix R_{b} from the processing apparatus which is not depicted.

As represented by the following Formula (10), the second singular matrix calculating unit 9 calculates the b-th second left singular matrix U_{b}″ from the rotation matrix R_{b} and the first left singular matrix U_{b}′.

$${U}_{b}^{″} = {U}_{b}^{′} {R}_{b} \qquad ( 10 )$$

Since the data size of the rotation matrix R_{b} is small, the processing load of calculation of the second left singular matrix U_{b}″ by the second singular matrix calculating unit 9 is smaller than the processing load of calculation of the second left singular matrix U_{b}″ by the second singular matrix calculating unit 8 depicted in FIG. 1.

In the second embodiment above, the compressing apparatus 101 depicted in FIG. 10 is configured in such a manner that the second singular matrix calculating unit 9 acquires the b-th first left singular matrix calculated by the first singular matrix calculating unit 7, and a b-th rotation matrix for rotating and the b-th first left singular matrix, and calculates a b-th second left singular matrix including left singular vectors corresponding to the singular values of the b-th target matrix from the b-th rotation matrix and the b-th first left singular matrix. Accordingly, similarly to the compressing apparatus 101 depicted in FIG. 1, the compressing apparatus 101 depicted in FIG. 10 can compress feature matrices simply by storing parts of the feature matrices on the memory, and, in addition to this, can reduce the processing load of calculation of the second left singular matrix U_{b}″ than the compressing apparatus 101 depicted in FIG. 1 can.

In the compressing apparatus 101 depicted in FIG. 10, the processing apparatus which is not depicted calculates the rotation matrix R_{b} for rotating the first left singular matrix U_{b}′. However, this is merely an example, and, as depicted in Formula (9), the second singular matrix calculating unit 9 may calculate the rotation matrix R_{b} for rotating the first left singular matrix U_{b}′. Note that, in this case, the processing load of calculation of the second left singular matrix U_{b}″ becomes similar to that of the compressing apparatus 101 depicted in FIG. 1.

### Third Embodiment

A compressing apparatus 101 explained in a third embodiment includes: a sampling unit 10 to output a b-th second left singular matrix U_{b}″ if the absolute value of the difference between a result of multiplication of a b-th first left singular matrix U_{b}′ and a b-th rotation matrix R_{b} and the b-th second left singular matrix U_{b}″ is equal to or greater than a first threshold Th₁, and not output the b-th second left singular matrix U_{b}″ if the absolute value of the difference is smaller than the first threshold Th₁.

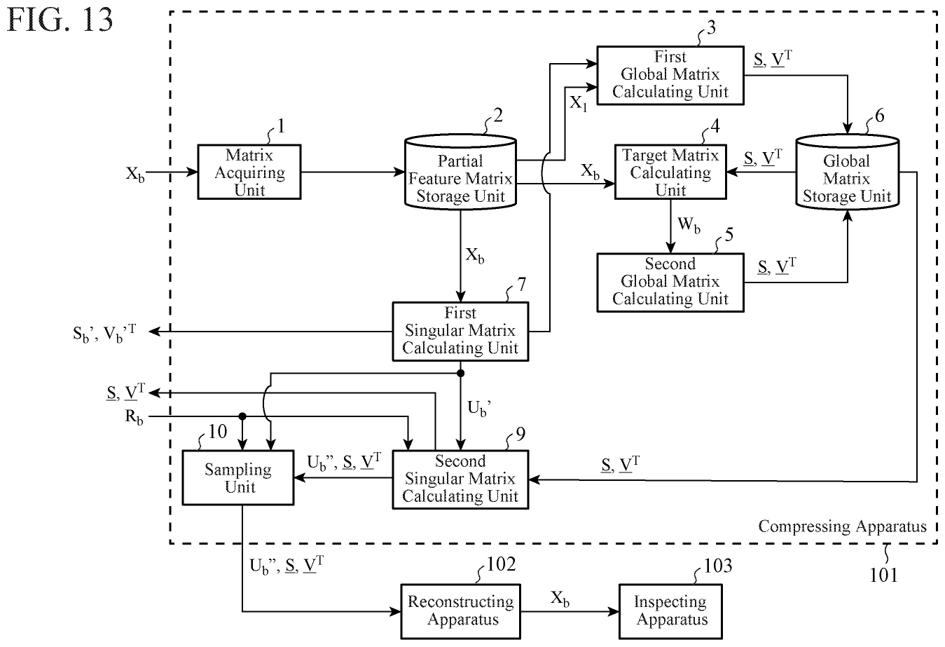

FIG. 13 is a configuration diagram depicting a system including the compressing apparatus 101 according to the third embodiment. Since reference signs in FIG. 13 that are identical to those in FIG. 1, FIG. 9, and FIG. 10 represent identical or equivalent portions, detailed explanations thereof are omitted.

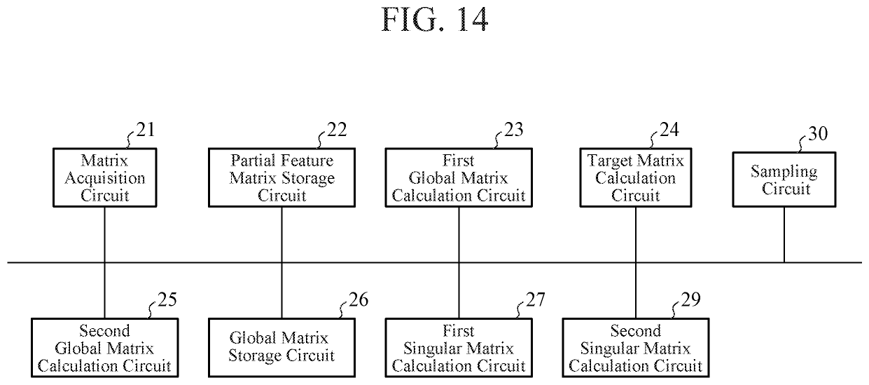

FIG. 14 is a hardware configuration diagram depicting hardware of the compressing apparatus 101 according to the third embodiment. Since reference signs in FIG. 14 that are identical to those in FIG. 2 and FIG. 11 represent identical or equivalent portions, detailed explanations thereof are omitted.

The compressing apparatus depicted in FIG. 13 includes a matrix acquiring unit 1, a partial feature matrix storage unit 2, a first global matrix calculating unit 3, a target matrix calculating unit 4, a second global matrix calculating unit 5, a global matrix storage unit 6, a first singular matrix calculating unit 7, a second singular matrix calculating unit 9, and the sampling unit 10.

For example, the sampling unit 10 is implemented by a sampling circuit 30 depicted in FIG. 14.

The sampling unit 10 acquires the b-th (b=1, . . . , B) first left singular matrix U_{b}′ from the first singular matrix calculating unit 7, and acquires the b-th second left singular matrix U_{b} ″, a b-th global singular value matrix S, and a b-th global right singular matrix V^{T} from the second singular matrix calculating unit 9.

The sampling unit 10 acquires the b-th rotation matrix R_{b} from a processing apparatus which is not depicted.

The sampling unit 10 calculates the absolute value of the difference between the result of the multiplication of the b-th first left singular matrix U_{b}′ and the b-th rotation matrix R_{b} and the b-th second left singular matrix U_{b}″.

The sampling unit 10 outputs the b-th second left singular matrix U_{b}″ to a reconstructing apparatus 102 if the absolute value of the difference is equal to or greater than the first threshold Th₁.

The sampling unit 10 does not output the b-th second left singular matrix U_{b}″ to the reconstructing apparatus 102 if the absolute value of the difference is smaller than the first threshold Th₁.

For example, the first threshold Th₁ may be stored on an internal memory of the sampling unit 10 or may be given from the outside of the compressing apparatus 101.

The compressing apparatus depicted in FIG. 13 is obtained by applying the sampling unit 10 to the compressing apparatus 101 depicted in FIG. 10. However, this is merely an example, and the sampling unit 10 may be applied to the compressing apparatus 101 depicted in FIG. 1 or the compressing apparatus 101 depicted in FIG. 9.

It is assumed in FIG. 13 that each of the matrix acquiring unit 1, the partial feature matrix storage unit 2, the first global matrix calculating unit 3, the target matrix calculating unit 4, the second global matrix calculating unit 5, the global matrix storage unit 6, the first singular matrix calculating unit 7, the second singular matrix calculating unit 9, and the sampling unit 10 which are constituent elements of the compressing apparatus 101 is implemented by dedicated hardware as depicted in FIG. 14. That is, it is assumed that the compressing apparatus 101 is implemented by a matrix acquisition circuit 21, a partial feature matrix storage circuit 22, a first global matrix calculation circuit 23, a target matrix calculation circuit 24, a second global matrix calculation circuit 25, a global matrix storage circuit 26, a first singular matrix calculation circuit 27, a second singular matrix calculation circuit 29, and the sampling circuit 30.

For example, each of the matrix acquisition circuit 21, the first global matrix calculation circuit 23, the target matrix calculation circuit 24, the second global matrix calculation circuit 25, the first singular matrix calculation circuit 27, the second singular matrix calculation circuit 29, and the sampling circuit 30 corresponds to a single circuit, a composite circuit, a programmed processor, a parallel-programmed processor, an ASIC, or an FPGA, or a combination of these.

The constituent elements of the compressing apparatus 101 are not limited to those implemented by dedicated hardware, but the compressing apparatus 101 may be implemented by software, firmware or a combination of software and firmware.

In a case where the compressing apparatus 101 is implemented by software, firmware, or the like, each of the partial feature matrix storage unit 2 and the global matrix storage unit 6 is configured on the memory 41 depicted in FIG. 3 of the computer. A compression program for causing the computer to execute a processing procedure in each of the matrix acquiring unit 1, the first global matrix calculating unit 3, the target matrix calculating unit 4, the second global matrix calculating unit 5, the first singular matrix calculating unit 7, the second singular matrix calculating unit 9, and the sampling unit 10 is stored on the memory 41. Then, the processor 42 depicted in FIG. 3 executes the compression program stored on the memory 41.

In addition, FIG. 14 depicts an example in which each of the constituent elements of the compressing apparatus 101 is implemented by dedicated hardware, and FIG. 3 depicts an example in which the compressing apparatus 101 is implemented by software, firmware, or the like. However, these are merely examples, and some constituent elements of the compressing apparatus 101 may be implemented by dedicated hardware, and the remaining constituent elements may be implemented by software, firmware, or the like.

Next, an operation performed by the compressing apparatus 101 depicted in FIG. 13 is explained. Note that those other than the sampling unit 10 are similar to their counterparts in the compressing apparatus 101 depicted in FIG. 10. Because of this, here, an operation performed by the sampling unit 10 is explained mainly.

The sampling unit 10 acquires the b-th (b=1, . . . , B) first left singular matrix U_{b}′ from the first singular matrix calculating unit 7, and acquires the b-th second left singular matrix U_{b} ″, the b-th global singular value matrix S, and the b-th global right singular matrix V^{T} from the second singular matrix calculating unit 9.

The sampling unit 10 acquires the b-th rotation matrix R_{b} from the processing apparatus which is not depicted.

The sampling unit 10 calculates the absolute value |U_{b}″-U_{b}′R_{b}|2 of the difference between a result of multiplication U_{b}′R_{b} of the b-th first left singular matrix U_{b}′ and the rotation matrix R_{b} and the b-th second left singular matrix U_{b} ″, and compares the absolute value |U_{b}″-U_{b}′R_{b}|2 of the difference and the first threshold Th₁.

As depicted in the following Formula (11), the sampling unit 10 outputs, to the reconstructing apparatus 102, the b-th second left singular matrix U_{b} ″, the b-th global singular value matrix S, and the b-th global right singular matrix V^{T} if the absolute value |U_{b}″-U_{b}′R_{b}|2 of the difference is equal to or greater than the first threshold Th₁.

$${\vert {U}_{b}^{″} - {U}_{b}^{′} {R}_{b} \vert}_{2} \geq {Th}_{1} \qquad ( 11 )$$

The sampling unit 10 does not output, to the reconstructing apparatus 102, the b-th second left singular matrix U_{b} ″, the b-th global singular value matrix S, and the b-th global right singular matrix V^{T} if the absolute value |U_{b}″-U_{b}′R_{b|2} of the difference is smaller than the first threshold Th₁.

Since, in a case where the absolute value |U_{b} ″-U_{b}′R_{b}|2 of the difference is smaller than the first threshold Th₁, an important feature is not included in a partial image related to the b-th second left singular matrix U_{b}″, the necessity for outputting the b-th second left singular matrix U_{b}″ to the reconstructing apparatus 102 is low in terms of reconstruction of an image.

In the third embodiment above, the compressing apparatus 101 depicted in FIG. 13 is configured to include the sampling unit 10 to output the b-th second left singular matrix if the absolute value of the difference between a result of multiplication of the b-th first left singular matrix calculated by the first singular matrix calculating unit 7 and the b-th rotation matrix and the b-th second left singular matrix calculated by the second singular matrix calculating unit 9 is equal to or greater than a first threshold, and not output the b-th second left singular matrix if the absolute value of the difference is smaller than the first threshold. Accordingly, similarly to the compressing apparatus 101 depicted in FIG. 1, the compressing apparatus 101 depicted in FIG. 13 can compress feature matrices simply by storing parts of the feature matrices on the memory, and, in addition to this, can enhance the compression rate of feature matrices than the compressing apparatus 101 depicted in FIGS. 1, 9, and 10 can.

### Fourth Embodiment

A compressing apparatus 101 explained in a fourth embodiment includes a sampling unit 11 to calculate the difference between each of a plurality of matrix elements included in a b-th rotation matrix R_{b} and each of a plurality of matrix elements included in an identity matrix I, outputs a b-th second left singular matrix U_{b}″ if the sum total of a plurality of the calculated differences is equal to or greater than a second threshold Th₂, and not output the b-th second left singular matrix U_{b}″ if the sum total of the differences is smaller than the second threshold Th₂.

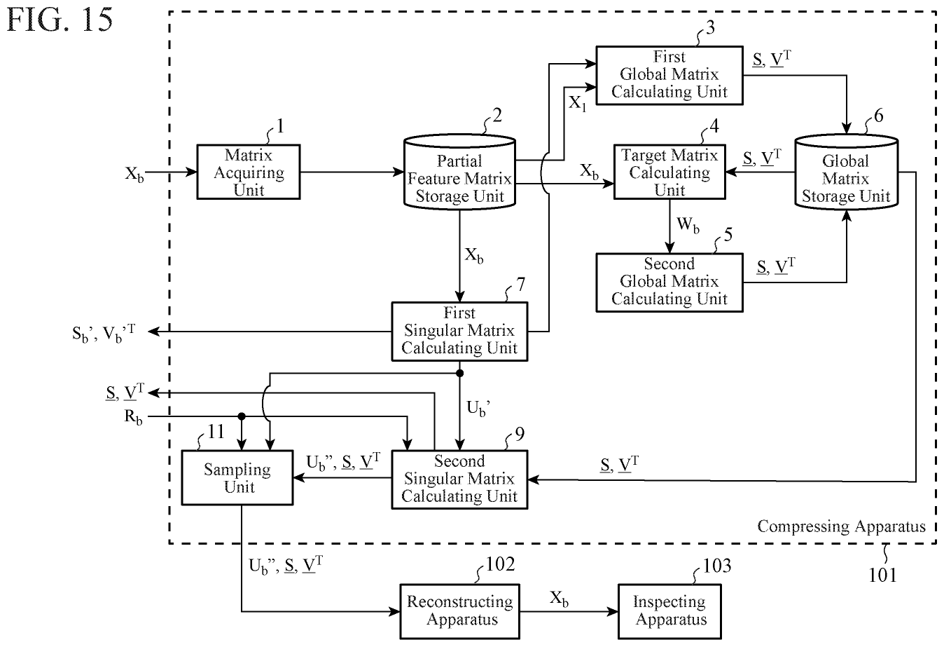

FIG. 15 is a configuration diagram depicting the system including a compressing apparatus 101 according to a fourth embodiment. Since reference signs in FIG. 15 that are identical to those in FIG. 1, FIG. 9, and FIG. 10 represent identical or equivalent portions, detailed explanations thereof are omitted.

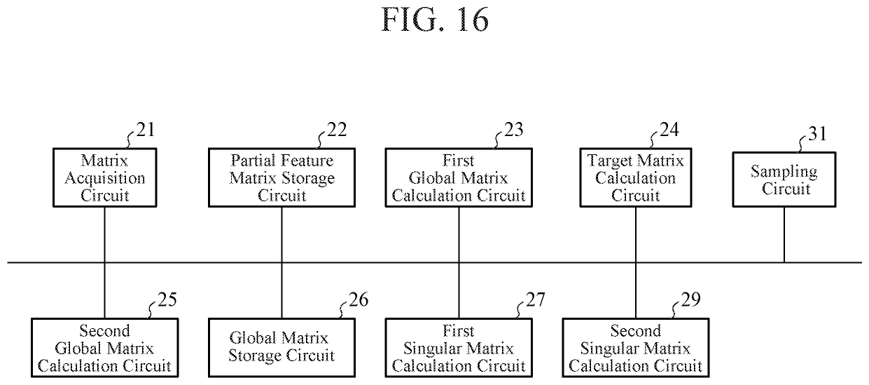

FIG. 16 is a hardware configuration diagram depicting hardware of the compressing apparatus 101 according to the fourth embodiment. Since reference signs in FIG. 16 that are identical to those in FIG. 2 and FIG. 11 represent identical or equivalent portions, detailed explanations thereof are omitted.

The compressing apparatus depicted in FIG. 15 includes a matrix acquiring unit 1, a partial feature matrix storage unit 2, a first global matrix calculating unit 3, a target matrix calculating unit 4, a second global matrix calculating unit 5, a global matrix storage unit 6, a first singular matrix calculating unit 7, a second singular matrix calculating unit 9, and the sampling unit 11.

For example, the sampling unit 11 is implemented by a sampling circuit 31 depicted in FIG. 16.

The sampling unit 11 acquires the b-th (b=1, . . . , B) first left singular matrix U_{b}′ from the first singular matrix calculating unit 7, and acquires the b-th second left singular matrix U_{b} ″, a b-th global singular value matrix S, and a b-th global right singular matrix V^{T} from the second singular matrix calculating unit 9.

The sampling unit 11 acquires the b-th rotation matrix R_{b} from a processing apparatus which is not depicted.

The sampling unit 11 calculates the difference between each of a plurality of matrix elements included in the rotation matrix R_{b} and each of a plurality of matrix elements included in the identity matrix I.

The sampling unit 11 outputs, to a reconstructing apparatus 102, the b-th second left singular matrix U_{b}″ if the sum total of a plurality of the calculated differences is equal to or greater than the second threshold Th₂.

The sampling unit 11 does not output, to the reconstructing apparatus 102, the b-th second left singular matrix U_{b}″ if the sum total of the plurality of calculated differences is smaller than the second threshold Th₂.

For example, the second threshold Th₂ may be stored on an internal memory of the sampling unit 11 or may be given from the outside of the compressing apparatus 101.

The compressing apparatus 101 depicted in FIG. 15 is obtained by applying the sampling unit 11 to the compressing apparatus 101 depicted in FIG. 10. However, this is merely an example, and the sampling unit 11 may be applied to the compressing apparatus 101 depicted in FIG. 1 or the compressing apparatus 101 depicted in FIG. 9.

It is assumed in FIG. 15 that each of the matrix acquiring unit 1, the partial feature matrix storage unit 2, the first global matrix calculating unit 3, the target matrix calculating unit 4, the second global matrix calculating unit 5, the global matrix storage unit 6, the first singular matrix calculating unit 7, the second singular matrix calculating unit 9, and the sampling unit 11 which are constituent elements of the compressing apparatus 101 is implemented by dedicated hardware as depicted in FIG. 16. That is, it is assumed that the compressing apparatus 101 is implemented by a matrix acquisition circuit 21, a partial feature matrix storage circuit 22, a first global matrix calculation circuit 23, a target matrix calculation circuit 24, a second global matrix calculation circuit 25, a global matrix storage circuit 26, a first singular matrix calculation circuit 27, a second singular matrix calculation circuit 29, and the sampling circuit 31.

For example, each of the matrix acquisition circuit 21, the first global matrix calculation circuit 23, the target matrix calculation circuit 24, the second global matrix calculation circuit 25, the first singular matrix calculation circuit 27, the second singular matrix calculation circuit 29, and the sampling circuit 31 corresponds to a single circuit, a composite circuit, a programmed processor, a parallel-programmed processor, an ASIC, or an FPGA, or a combination of these.

The constituent elements of the compressing apparatus 101 are not limited to those implemented by dedicated hardware, but the compressing apparatus 101 may be implemented by software, firmware or a combination of software and firmware.

In a case where the compressing apparatus 101 is implemented by software, firmware, or the like, each of the partial feature matrix storage unit 2 and the global matrix storage unit 6 is configured on the memory 41 depicted in FIG. 3 of the computer. A compression program for causing the computer to execute a processing procedure in each of the matrix acquiring unit 1, the first global matrix calculating unit 3, the target matrix calculating unit 4, the second global matrix calculating unit 5, the first singular matrix calculating unit 7, the second singular matrix calculating unit 9, and the sampling unit 11 is stored on the memory 41. Then, the processor 42 depicted in FIG. 3 executes the compression program stored on the memory 41.

In addition, FIG. 16 depicts an example in which each of the constituent elements of the compressing apparatus 101 is implemented by dedicated hardware, and FIG. 3 depicts an example in which the compressing apparatus 101 is implemented by software, firmware, or the like. However, these are merely examples, and some constituent elements of the compressing apparatus 101 may be implemented by dedicated hardware, and the remaining constituent elements may be implemented by software, firmware, or the like.

Next, an operation performed by the compressing apparatus 101 depicted in FIG. 15 is explained. Note that those other than the sampling unit 11 are similar to their counterparts in the compressing apparatus 101 depicted in FIG. 10. Because of this, an operation performed by the sampling unit 11 is mainly explained here.

The sampling unit 11 acquires the b-th second left singular matrix U_{b} ″, the b-th global singular value matrix S, and the b-th global right singular matrix V^{T} from the second singular matrix calculating unit 9.

The sampling unit 11 acquires the b-th rotation matrix R_{b} from the processing apparatus which is not depicted.

As represented by the following Formula (12), the sampling unit 11 calculates the difference d_{p,q} between each of a plurality of matrix elements r_{p,q} (p=1, . . . , K:q=1, . . . , K) included in the rotation matrix R_{b} and each of a plurality of matrix elements ip,q included in the identity matrix I.

$$[ \begin{matrix}{d}_{1 , 1} & … & {d}_{1 , K} \\ ⋮ & ⋱ & ⋮ \\ {d}_{K , 1} & … & {d}_{K , K}\end{matrix} ] = [ \begin{matrix}{r}_{1 , 1} & … & {r}_{1 , K} \\ ⋮ & ⋱ & ⋮ \\ {r}_{K , 1} & … & {r}_{K , K}\end{matrix} ] - [ \begin{matrix}{i}_{1 , 1} & … & 0 \\ ⋮ & ⋱ & ⋮ \\ 0 & … & {i}_{K , K}\end{matrix} ] \qquad ( 12 )$$

As represented by the following Formula (13), the sampling unit 11 calculates the sum total D of a plurality of the differences d_{p,q} (p=1, . . . , K: q=1, . . . , K).

$$D = {\sum }_{p = 1}^{K} {\sum }_{q = 1}^{K} {d}_{p , q} \qquad ( 13 )$$

The sampling unit 11 compares the sum total D of the plurality of differences d_{p,q} and the second threshold Th₂.

As represented by the following Formula (14), the sampling unit 11 outputs, to the reconstructing apparatus 102, the b-th second left singular matrix U_{b}″, the b-th global singular value matrix S, and the b-th global right singular matrix V^{T} if the sum total D of the plurality of differences d_{p,q} is equal to or greater than the second threshold Th₂.

$$D \geq T {h}_{2} \qquad ( 14 )$$

The sampling unit 11 does not output, to the reconstructing apparatus 102, the b-th second left singular matrix U_{b} ″, the b-th global singular value matrix S, and the b-th global right singular matrix V^{T} if the sum total D of the plurality of differences d_{p,q} is smaller than the second threshold Th₂.

Since, in a case where the sum total D of the plurality of differences d_{p,q} is smaller than the second threshold Th₂, an important feature is not included in the b-th second left singular matrix U_{b}″, the necessity for outputting the b-th second left singular matrix U_{b}″ to the reconstructing apparatus 102 is low in terms of reconstruction of an image.

In the fourth embodiment above, the compressing apparatus 101 depicted in FIG. 15 is configured to include the sampling unit 11 to calculate the difference between each of a plurality of matrix elements included in the rotation matrix and each of a plurality of matrix elements included in an identity matrix, output the b-th second left singular matrix calculated by the second singular matrix calculating unit 9 if the sum total of a plurality of the calculated differences is equal to or greater than a second threshold, and not output the b-th second left singular matrix if the sum total of the differences is smaller than the second threshold. Accordingly, similarly to the compressing apparatus 101 depicted in FIG. 1, the compressing apparatus 101 depicted in FIG. 15 can compress feature matrices simply by storing parts of the feature matrices on the memory, and, in addition to this, can enhance the compression rate of feature matrices than the compressing apparatus 101 depicted in FIGS. 1, 9, and 10 can.

Note that any combination of embodiments, modification of any constituent element of each embodiment, or omission of any constituent element of each embodiment is possible in the present disclosure.

### INDUSTRIAL APPLICABILITY

The present disclosure is suitable for a compressing apparatus, a compression method, a medium, and a system.

### REFERENCE SIGNS LIST

1: matrix acquiring unit, 2: partial feature matrix storage unit, 3: first global matrix calculating unit, 4: target matrix calculating unit, 5: second global matrix calculating unit, 6: global matrix storage unit, 7: first singular matrix calculating unit, 8, 9: second singular matrix calculating unit, 10, 11: sampling unit, 12: storage unit, 21: matrix acquisition circuit, 22: partial feature matrix storage circuit, 23: first global matrix calculation circuit, 24: target matrix calculation circuit, 25: second global matrix calculation circuit, 26: global matrix storage circuit, 27: first singular matrix calculation circuit, 28, 29: second singular matrix calculation circuit, 30, 31: sampling circuit, 41: memory, 42: processor, 101: compressing apparatus, 102: reconstructing apparatus, 103: inspecting apparatus

1. A compressing apparatus comprising:
matrix acquiring circuitry to sequentially acquire a partial feature matrix for each of a plurality of partial images that are obtained by splitting an image;
first global matrix calculating circuitry to calculate a first global singular value matrix which is a first global singular value matrix and includes a singular value of a first partial feature matrix, and a first global right singular matrix which is a first global right singular matrix and includes a right singular vector corresponding to the singular value of the first partial feature matrix, by singular-value-decomposing the first partial feature matrix which is a partial feature matrix acquired first by the matrix acquiring circuitry;
target matrix calculating circuitry to calculate a b-th target matrix which is a matrix of a b-th singular value decomposition target and includes: a b-th partial feature matrix which is a partial feature matrix acquired b-th (b is an integer which is equal to or greater than two) by the matrix acquiring circuitry, a (b-1)-th global singular value matrix, and a (b-1)-th global right singular matrix; and
second global matrix calculating circuitry to singular-value-decompose the b-th target matrix calculated by the target matrix calculating circuitry, calculate, as a b-th global singular value matrix, a singular value matrix of the b-th target matrix including a singular value of the b-th target matrix, and calculate, as a b-th global right singular matrix, a right singular matrix of the b-th target matrix including a right singular vector corresponding to the singular value of the b-th target matrix.

2. The compressing apparatus according to claim 1, comprising first singular matrix calculating circuitry to singular-value-decompose the b-th partial feature matrix acquired b-th by the matrix acquiring circuitry, and calculate a b-th first singular value matrix including a singular value of the b-th partial feature matrix, a b-th first left singular matrix including a left singular vector corresponding to the singular value of the b-th partial feature matrix, and a b-th first right singular matrix including a right singular vector corresponding to the singular value of the b-th partial feature matrix.

3. The compressing apparatus according to claim 2, comprising second singular matrix calculating circuitry to calculate a b-th second left singular matrix including a left singular vector corresponding to the singular value of the b-th target matrix, from the b-th global singular value matrix calculated by the second global matrix calculating circuitry, the b-th global right singular matrix calculated by the second global matrix calculating circuitry, the b-th first singular value matrix calculated by the first singular matrix calculating circuitry, the b-th first left singular matrix calculated by the first singular matrix calculating circuitry, and the b-th first right singular matrix calculated by the first singular matrix calculating circuitry.

4. The compressing apparatus according to claim 3, comprising storage circuitry to store the b-th second left singular matrix calculated by the second singular matrix calculating circuitry, the b-th global singular value matrix calculated by the second global matrix calculating circuitry, and the b-th global right singular matrix calculated by the second global matrix calculating circuitry.

5. The compressing apparatus according to claim 2, comprising second singular matrix calculating circuitry to acquire the b-th first left singular matrix calculated by the first singular matrix calculating circuitry, and a b-th rotation matrix for rotating the b-th first left singular matrix, and calculate a b-th second left singular matrix including a left singular vector corresponding to the singular value of the b-th target matrix from the b-th rotation matrix and the b-th first left singular matrix.

6. The compressing apparatus according to claim 5, wherein the second singular matrix calculating circuitry calculates the b-th rotation matrix, from the b-th global singular value matrix calculated by the second global matrix calculating circuitry, the b-th global right singular matrix calculated by the second global matrix calculating circuitry, the b-th first singular value matrix calculated by the first singular matrix calculating circuitry, and the b-th first right singular matrix calculated by the first singular matrix calculating circuitry.

7. The compressing apparatus according to claim 5, comprising sampling circuitry to output the b-th second left singular matrix if an absolute value of a difference between a result of multiplication of the b-th first left singular matrix calculated by the first singular matrix calculating circuitry and the b-th rotation matrix and the b-th second left singular matrix calculated by the second singular matrix calculating circuitry is equal to or greater than a first threshold, and not output the b-th second left singular matrix if the absolute value of the difference is smaller than the first threshold.

8. The compressing apparatus according to claim 5, comprising sampling circuitry to calculate differences between a plurality of matrix elements included in the rotation matrix and a plurality of matrix elements included in an identity matrix, output the b-th second left singular matrix calculated by the second singular matrix calculating circuitry if a sum total of the calculated differences is equal to or greater than a second threshold, and not output the b-th second left singular matrix if the sum total of the differences is smaller than the second threshold.

9. The compressing apparatus according to claim 1, wherein
the image is an inspection image including an object for inspection, and
the compressing apparatus is an apparatus to compress the inspection image.

10. A compression method comprising:
sequentially acquiring a partial feature matrix for each of a plurality of partial images that are obtained by splitting an image;
calculating a first global singular value matrix which is a first global singular value matrix and includes a singular value of a first partial feature matrix, and a first global right singular matrix which is a first global right singular matrix and includes a right singular vector corresponding to the singular value of the first partial feature matrix, by singular-value-decomposing the first partial feature matrix which is a partial feature matrix acquired;
calculating a b-th target matrix which is a matrix of a b-th singular value decomposition target and includes: a b-th partial feature matrix which is a partial feature matrix acquired b-th (b is an integer which is equal to or greater than two), a (b-1)-th global singular value matrix, and a (b-1)-th global right singular matrix; and
singular-value-decomposing the b-th target matrix calculated, calculating, as a b-th global singular value matrix, a singular value matrix of the b-th target matrix including a singular value of the b-th target matrix, and calculating, as a b-th global right singular matrix, a right singular matrix of the b-th target matrix including a right singular vector corresponding to the singular value of the b-th target matrix.

11. A non-transitory computer-readable medium storing a compression program for causing a computer to execute:
a processing procedure of sequentially acquiring a partial feature matrix for each of a plurality of partial images that are obtained by splitting an image;
a processing procedure of calculating a first global singular value matrix which is a first global singular value matrix and includes a singular value of a first partial feature matrix, and a first global right singular matrix which is a first global right singular matrix and includes a right singular vector corresponding to the singular value of the first partial feature matrix, by singular-value-decomposing the first partial feature matrix which is a partial feature matrix acquired first;
a processing procedure of calculating a b-th target matrix which is a matrix of a b-th singular value decomposition target and includes: a b-th partial feature matrix which is a partial feature matrix acquired b-th (b is an integer which is equal to or greater than two), a (b-1)-th global singular value matrix, and a (b-1)-th global right singular matrix; and
a processing procedure of singular-value-decomposing the b-th target matrix calculated, calculating, as a b-th global singular value matrix, a singular value matrix of the b-th target matrix including a singular value of the b-th target matrix, and calculating, as a b-th global right singular matrix, a right singular matrix of the b-th target matrix including a right singular vector corresponding to the singular value of the b-th target matrix.

12. A system comprising:
the compressing apparatus according to claim 3, and
a reconstructing apparatus to reconstruct a pre-splitting original image of the plurality of partial images on a basis of the b-th second left singular matrix calculated by the second singular matrix calculating circuitry, the b-th global singular value matrix calculated by the second global matrix calculating circuitry, and the b-th global right singular matrix calculated by the second global matrix calculating circuitry.

13. The system according to claim 12, comprising an inspecting apparatus to inspect an object included in a post-reconstruction image obtained by the reconstructing apparatus on a basis of the post-reconstruction image.
